(19) United States
(12) Patent Application Publication
(10) Pub. No.: US 2017/0253976 A1
(43) Pub. Date: Sep. 7, 2017

(54) METHOD FOR MONITORING A PART VIA COLORIMETRY

(71) Applicant: AIRBUS SAFRAN LAUNCHERS SAS, Paris (FR)

(72) Inventors: Maxime PERON, Pessac (FR); Marie BETAILLE-FRANCOUAL, Merignac (FR)

(21) Appl. No.: 15/510,466

(22) PCT Filed: Sep. 10, 2015
(86) PCT No.: PCT/FR2015/052411

§ 371 Date: Mar. 10, 2017

(30) Foreign Application Priority Data
Sep. 12, 2014 (FR) 1402041

(51) Int. Cl. C23C 22/77; G01J 3/46; G01J 3/50

(52) U.S. Cl. CPC C23C 22/77; G01J 3/50; G01J 3/463; C23C 2222/10

(57) ABSTRACT

A method of fabricating and inspecting a part, the method including the following steps a) treating a substrate including aluminum by a chemical conversion method making use of a treatment solution including chromium with a degree of oxidation of +III in order to obtain a part presenting a chemical conversion layer; and b) inspecting the presence of the chemical conversion layer obtained during step a) by using a colorimeter to measure the color of the chemical conversion layer and by comparing the measured color with a reference color.

### BACKGROUND OF THE INVENTION

The invention relates to methods of fabricating and inspecting parts that present a layer obtained by chemical conversion.

It is known to perform chemical conversion treatments on the surfaces of aluminum substrates. The coatings that are obtained after such treatments may be of thickness that is relatively small, less than a few hundreds of nanometers. Such coatings can be relatively difficult to detect by conventional technologies because of their small thickness.

Furthermore, “registration, evaluation and authorization of chemicals” (REACh) regulations require certain existing chemical conversion methods to be modified in order to avoid using chromium with degree of oxidation +VI. In order to comply with those regulations, new chemical conversion treatments have been developed that are based on chromium with degree of oxidation +III.

The coatings obtained as a result of performing new chemical conversion methods based on chromium with degree of oxidation +III can present relatively little color and they appear to the naked eye to be very similar in appearance to the substrate being treated or to other coatings that might be present thereon. This fact can make such chemical conversion coatings even more difficult to detect. Thus, in particular, it can be difficult to detect re-working operations based on chemical conversion using chromium with degree of oxidation +III, when performed on parts that have previously been treated by anodic oxidation or by chemical conversion. That can thus lead to lengthening of the time required for inspecting the resulting part, and possibly even to a potential risk of the part suffering deterioration if it has just been considered as requiring additional treatments to be performed.

Consequently, there exists a need to have a new method of detecting a chemical conversion layer obtained by treating a substrate using chromium with degree of oxidation +III.

There also exists a need to have available a novel method of detecting such a chemical conversion layer that is simple and fast to use and that can enable parts to be inspected non-destructively.

### OBJECT AND SUMMARY OF THE INVENTION

To this end, in a first aspect, the invention proposes a method of fabricating and inspecting a part, the method comprising the following steps:

a) treating a substrate including aluminum by a chemical conversion method making use of a treatment solution including chromium with a degree of oxidation of +III in order to obtain a part presenting a chemical conversion layer; and b) inspecting the presence of the chemical conversion layer obtained during step a) by using a colorimeter to measure the color of said chemical conversion layer and by comparing the measured color with a reference color.

The invention provides a simple method of inspection that makes it possible to verify quickly and reliably that the chemical conversion treatment of step a) has been performed properly. The invention thus makes it possible to determine clearly whether the chemical conversion treatment of step a) has been performed, and thus avoid additional and superfluous treatment operations on the part, thereby making it possible to accelerate and simplify the treatment of the part. The chemical conversion layer obtained during step a) is of relatively small thickness, e.g. less than or equal to 500 nanometers (nm), and the invention thus provides a method that is simple and fast for detecting the presence of such a coating of small thickness.

Methods of chemical conversion suitable for use during step a) are known to the person skilled in the art. By way of example, the following commercial solutions may be mentioned as treatment solutions that are suitable for use: SurTec° 650, SurTec° 650 V, and LANTHANE 613.3.

The substrate treated during step a) may include an aluminum alloy, e.g. selected from the following aluminum alloys: 2024, 5086, 7010, and AS7G0,3.

In an implementation, an initial anodic oxidation or chemical conversion coating may be formed on the substrate before step a), and in that the chemical conversion layer obtained during step a) may be adjacent to the initial coating. In particular, after step a), the initial coating may surround all or part of the chemical conversion layer obtained during step a).

The initial coating may be formed by any type of anodic or chemical conversion. By way of example, it may be formed by performing chemical conversion as described above or by performing sulfuric acid anodizing (SAA), chromic acid anodizing (CAA), tartaric sulfuric acid anodizing (TSAA), or phosphoric sulfuric acid anodizing (PSAA).

In an implementation, the chemical conversion treatment performed during step a) may be a reworking operation during which the treatment solution is applied locally on the substrate by means of an applicator.

By way of example, the applicator used in the reworking treatment may be a paintbrush enabling the treated surface to be impregnated with the treatment solution.

In an implementation, the colorimeter may be in the form of a handheld tool.

It is advantageous to use a portable colorimeter in order to facilitate performing the inspection and in order to improve the speed with which it is executed.

By way of example, the colorimeter may be a spectrocolorimeter. By way of example, it is possible to use the spectrocolorimeter sold under the reference CM-700d by the supplier Konica Minolta

In an implementation, the reference color may be stored prior to step b) in a data storage medium.

In such a configuration, there is no need to measure the reference color during step b), since it is already in memory. Thus, advantageously this configuration makes it possible for the colorimeter to be used in step b) to measure only the color of the chemical conversion layer obtained during step a). Consequently, such an implementation makes it possible to reduce the number of color measurements taken by the colorimeter during step b) and thus to further improve the speed with which the inspection method is performed.

The data storage medium may be integrated in the colorimeter. In a variant, the storage medium is integrated in a computer system distinct from the colorimeter, the colorimeter being configured to exchange data with the computer system, e.g. by a wireless data exchange network.

In a variant, the reference color may be measured by the colorimeter during step b). Under such circumstances, during step b), the colorimeter measures the color of the chemical conversion layer obtained during step a), and also measures the reference color, these two measured colors then being compared.

Naturally, during step b), it is possible to inspect a plurality of parts in succession, which parts may (but need not) have been obtained by performing the same step a).

The colors measured or used by the colorimeter during step b) may be defined in the L*a*b* color space. Under such circumstances, the colors are defined by three coordinates, namely: the lightness coordinate-L*, the red-green color coordinate a*, and the yellow-blue color coordinate b*. When two colors are defined in the L*a*b* color space, it is possible to compare them during step b) by calculating the color difference ΔE*_{ab} between these two colors by applying the following formula:

ΔE*_{ab}=\sqrt{ΔL*²+Δa*²+Δb*²}.

Naturally, it would not go beyond the ambit of the invention when the colors used in step b) are defined in a color space other than the L*a*b* space.

The color measurement(s) performed by the colorimeter during step b) may be performed with specular component reflection included (SC' measurement mode). In a variant, the color measurement(s) may be performed with specular component reflection excluded (SCE measurement mode).

Unless mentioned to the contrary, the color of a zone measured by the colorimeter during step b) corresponds to the arithmetic mean of colors measured at five points of said zone. For example, when a color of a zone measured during step b) is defined in the L*a*b* space, the L*, a*, and b* coordinates are averaged over the various measurement points in order to deduce the color of said zone therefrom.

In an implementation, the reference color may correspond to the color of a reference chemical conversion layer formed using step a) (i.e. on a substrate having the same chemical nature and by using the same chemical conversion treatment as in step a)).

Under such circumstances, when the colors are defined in the L*a*b* space, it may be considered that step a) has been properly performed if a color difference ΔE*_{ab} is obtained during step b) that is less than or equal to a predefined value that is a function of the substrate and of the surface treatment that has been performed, e.g. less than or equal to 4, e.g. less than or equal to 3.5.

In a variant, the reference color may correspond to the color of a reference layer obtained by performing treatment different from that performed in step a). Under such circumstances, when the colors are defined in the L*a*b* space, it is possible during step b) to evaluate whether the colorimetric difference ΔE*_{ab} is close to a predefined value in order to determine whether step a) has been properly performed.

### BRIEF DESCRIPTION OF THE DRAWINGS

Other characteristics and advantages of the invention appear from the following description of particular implementations of the invention, given as nonlimiting examples, and with reference to the accompanying drawing, in which:

FIG. 1 shows in a highly diagrammatic and fragmentary manner a plan view of an example of a part obtained after performing a step a) of the invention; and

FIG. 2 shows in a highly diagrammatic and fragmentary manner a plan view of another example of a part obtained after performing a step a) of the invention.

### EXAMPLES

### Example 1

### Step a) Performed After Making an Initial Coating by Chemical Conversion

In this example, a substrate made of aluminum alloy 5086 was initially coated with an initial coating obtained by immersing the substrate in a SurTec° 650 treatment solution.

Thereafter, a step a) of the invention was performed wherein reworking chemical conversion treatment was performed after the initial coating had been formed. The treatment solution used during this step a) is sold under the name SurTec® 650 and it was applied by means of a stick.

A zone adjacent to the zone treated by the reworking treatment was left cleaned.

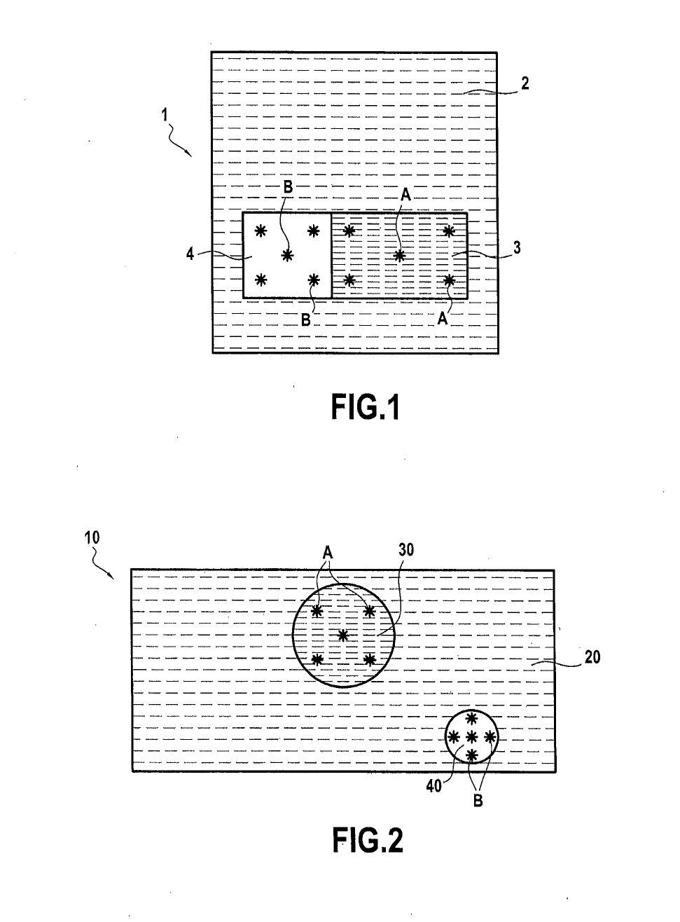

FIG. 1 is a very diagrammatic plan view of the part 1 obtained in that way. In this figure, the initial coating is represented by the symbol 2, the zone reworked by chemical conversion by the symbol 3, and the stripped zone by the symbol 4. As shown, the chemical conversion layer 3 obtained during step a) is adjacent to the initial coating 2, with the initial coating 2 surrounding the layer 3.

To the naked eye, the reworked zone 3 and the stripped zone 4 are very difficult to distinguish from each other.

The measurements of step b) were performed using a Konica Minolta CM-700d colorimeter in specular component included (SCI) mode. The CIE Lab color space was used.

As shown in FIG. 1, for each of the zones in which color was measured during step b), the L*, a*, and b* coordinates were measured at five points in each of these zones, with the results obtained then being averaged over those five points (arithmetic mean) in order to determine the color of the zone in question. FIG. 1 shows diagrammatically the measurement points A of the zone 3 reworked by chemical conversion and the measurement points B of the stripped zone 4.

Initially, the color of the reference zone was evaluated, this color corresponding to the reference color. The reference zone corresponds to a reference chemical conversion layer formed in accordance with step a) of the present example, i.e. on a 5086 alloy and by using the same chemical conversion treatment.

A reference color was obtained after calculating an average over the five measurement points, and it presented the color coordinates given in detail in Table 1 below.

TABLE 1

| | L* | a* | b* |
|---|---|---|---|
| Reference color | 84.12 | 0.09 | −2.09 |

Thereafter, the colors of the chemical conversion layer obtained during step a) and of the stripped zone were measured.

A color was obtained for each of these zones by calculating an average over five measurement points, and they presented the results set out in Table 2 below. For each of these two zones, the color differences relative to the reference color are given in the column ΔE*ab.

TABLE 2

| | L* | a* | b* | ΔE*ab |
|---|---|---|---|---|
| Stripped zone | 88.89 | −0.05 | 0.64 | 5.50 |
| Chemical conversion | 83.69 | 0.14 | −1.56 | 0.69 |
| layer obtained during | | | | |
| step a) | | | | |

A significant color difference was obtained between the color of the stripped zone and the reference color (5.50), which shows that the method of the invention makes it possible to distinguish between two different surfaces even though they are similar in appearance to the naked eye. Also, the color difference between the color of the chemical conversion layer obtained during step a) and the reference color is small (0.69). Such a color difference value serves to confirm that step a) was performed correctly.

### Example 2

### Step a) Performed After Making an Initial Coating by Anodization

In this example, a substrate made of aluminum 7010 alloy was initially coated by an initial coating obtained by chromium acid anodizing using chromium with degree of oxidation +VI.

Thereafter, a step a) of the invention was performed wherein reworking chemical conversion treatment was performed after the initial coating had been formed. The treatment solution used during this step a) is sold under the name SurTec® 650 and it was applied by means of a stick.

A zone distinct from the zone treated by the reworking treatment was stripped.

FIG. 2 is a very diagrammatic plan view of the part 10 obtained in that way. In this figure, the initial coating is represented by the symbol 20, the zone reworked by chemical conversion by the symbol 30, and the stripped zone by the symbol 40. As shown, the chemical conversion layer 30 obtained during step a) is adjacent to the initial coating 20, with the initial coating 20 surrounding the layer 30.

To the naked eye, the reworked and stripped zones are very difficult to distinguish from each other.

The measurements of step b) were performed using a Konica Minolta CM-700d colorimeter in specular component included (SCI) mode. The CIE Lab color space was used.

As shown in FIG. 2, for each of the zones in which color was measured during step b), the L*, a*, and b* coordinates were measured at five points in each of these zones, with the results obtained then being averaged over those five points (arithmetic mean) in order to determine the color of the zone in question. FIG. 2 shows diagrammatically the measurement points A of the zone 30 reworked by chemical conversion and the measurement points B of the stripped zone 40.

Initially, the color of the reference zone was evaluated, this color corresponding to the reference color. The reference zone corresponds to a reference chemical conversion layer formed in accordance with step a) of the present example, i.e. on a 7010 alloy and by using the same chemical conversion treatment.

A reference color was obtained after calculating an average over the five measurement points, and it presented the color coordinates given in detail in Table 3 below.

TABLE 3

| | L* | a* | b* |
|---|---|---|---|
| Reference color | 81.57 | 0.24 | −1.64 |

Thereafter, the colors of the chemical conversion layer obtained during step a) and of the stripped zone were measured.

A color was obtained for each of these zones by calculating an average over five measurement points, and they presented the results set out in Table 4 below. For each of these two zones, the color differences relative to the reference color are given in the columns ΔE*ab.

TABLE 4

| | L* | a* | b* | ΔE*ab |
|---|---|---|---|---|
| Stripped zone | 78.79 | −0.01 | 0.86 | 3.74 |
| Chemical conversion | 82.50 | 0.35 | −1.28 | 1.00 |
| layer obtained during | | | | |
| step a) | | | | |

A significant color difference was obtained between the color of the stripped zone and the reference color (3.74), which means that the surfaces are different. Also,, the color difference measured between the color of the chemical conversion layer obtained during step a) and the reference color is small (1.00). Such a color difference value serves to confirm that step a) was performed correctly.

The term “including/containing/comprising a” should be understood as “including/containing/comprising at least one”.

The term “lying in the range . . . to . . .” should be understood as including the limits.

1. A method of fabricating and inspecting a part, the method comprising the following steps:
a) treating a substrate including aluminum by a chemical conversion method making use of a treatment solution including chromium with a degree of oxidation of +III in order to obtain a part presenting a chemical conversion layer; and
b) inspecting the a presence of the chemical conversion layer obtained during step a) by using a colorimeter to measure the color of said chemical conversion layer and by comparing the measured color with a reference color.

2. A method according to claim 1, wherein an initial anodic oxidation or chemical conversion coating is formed on the substrate before step a), and wherein the chemical conversion layer obtained during step a) is adjacent to the initial coating.

3. A method according to claim 1, wherein the chemical conversion treatment performed during step a) is a reworking operation during which the treatment solution is applied locally on the substrate by means of an applicator.

4. A method according to any one of claims 1, wherein the colorimeter is in the form of a handheld tool.
